(19) United States
(12) Patent Application Publication
(10) Pub. No.: US 2012/0280585 A1
(43) Pub. Date: Nov. 8, 2012

(54) TANDEM ELECTRIC MOTOR VEHICLE DRIVE SYSTEM

(75) Inventor: Jacob Shaffer, Phoenix, AZ (US)

(73) Assignee: REMY TECHNOLOGIES, L.L.C., Pendleton, IN (US)

(21) Appl. No.: 13/100,917

(22) Filed: May 4, 2011

(51) Int. Cl. H02K 7/116

(52) U.S. Cl. 310/83

(57) ABSTRACT

A vehicle drive system includes a first electric motor having a first motor housing and a first motor shaft, a second electric motor having a second motor housing and a second motor shaft, and a gear system operatively connecting the first motor shaft and the second motor shaft. The gear system is configured and disposed to transmit torque from the first motor shaft to the second motor shaft to form a tandem electric motor drive system.

### BACKGROUND OF THE INVENTION

Exemplary embodiments pertain to the art of vehicle drive systems and, more particularly, to a tandem electric motor drive system.

Fuel cost and desire to reduce emissions are factors that encourage manufacturers to explore alternative energy sources. Currently, several manufacturers are turning to electric motors, either alone or in combination with a fossil fuel engines, as a power source for motor vehicles. When combined with a fossil fuel engine, the electric motor provides support during periods of higher power and/or torque demand, such as during rapid accelerations, high speed cruising, and hill climbing. When used as a sole source of power, electric motors draw a generally steady current during normal cruising but draw high currents during periods of higher power/torque demand. The higher current draw may reduce an overall range of the vehicle.

### BRIEF DESCRIPTION OF THE INVENTION

Disclosed is a vehicle drive system including a first electric motor having a first motor housing and a first motor shaft, a second electric motor having a second motor housing and a second motor shaft, and a gear system operatively connecting the first motor shaft and the second motor shaft. The gear system is configured and disposed to transmit torque from the first motor shaft to the second motor shaft to form a tandem electric motor drive system.

Also disclosed is a method of operating a tandem electric motor vehicle drive system. The method includes activating a first electric motor having a first motor shaft, and activating a second electric motor having a second motor shaft operatively connected to the first motor shaft through a gear system. Output from the second electric motor adds to output from the first electric motor to provide a motive force to a vehicle.

### BRIEF DESCRIPTION OF THE DRAWINGS

The following descriptions should not be considered limiting in any way. With reference to the accompanying drawings, like elements are numbered alike:

FIG. 1 depicts a vehicle drive system including tandem electric motors connected through a gear system in accordance with an exemplary embodiment;

FIG. 2 depicts a vehicle drive system including tandem electric motors connected through a gear system in accordance with another aspect of the exemplary embodiment;

FIG. 3 depicts a vehicle drive system including tandem electric motors connected through a gear system in accordance with still another aspect of the exemplary embodiment;

FIG. 4 depicts a vehicle drive system including tandem electric motors connected through a gear system in accordance with yet another exemplary embodiment; and

FIG. 5 depicts a vehicle drive system including tandem electric motors connected through a gear system in accordance with still yet another exemplary embodiment.

### DETAILED DESCRIPTION OF THE INVENTION

A detailed description of one or more embodiments of the disclosed apparatus and method are presented herein by way of exemplification and not limitation with reference to the Figures.

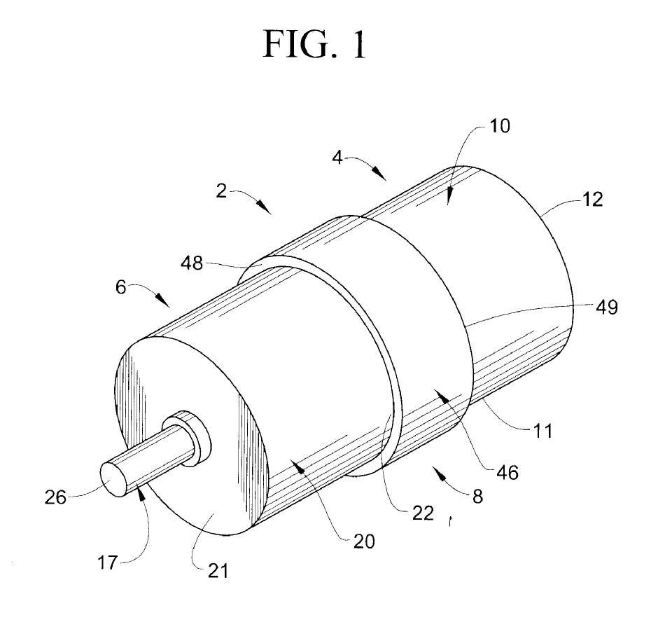

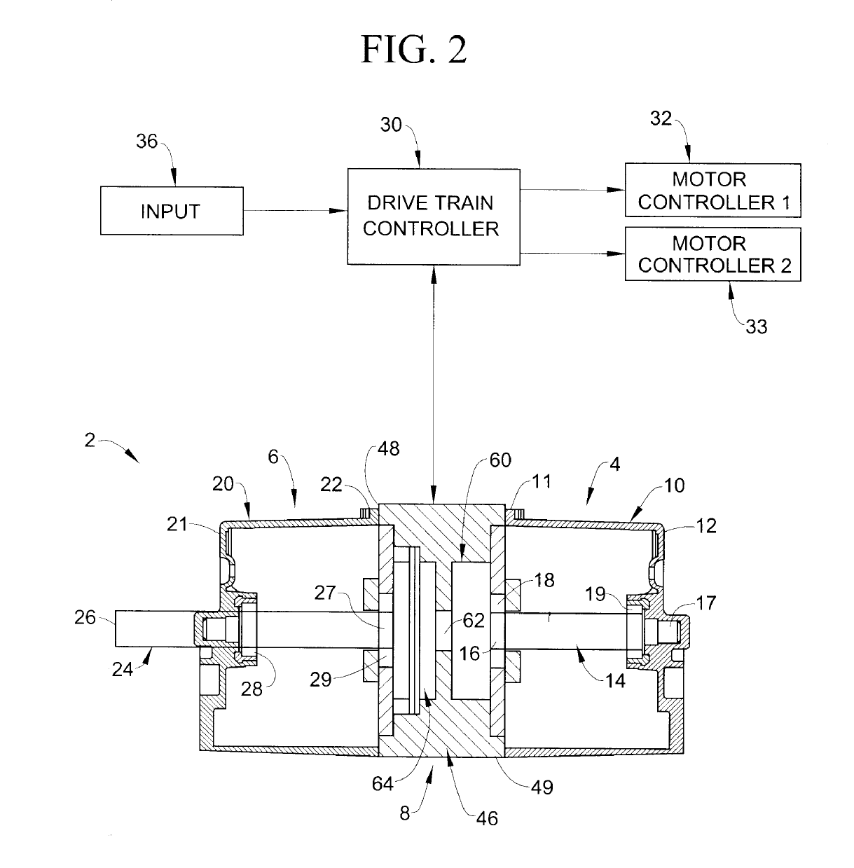

With reference to FIGS. 1 and 2, a vehicle drive system constructed in accordance with an exemplary embodiment is indicated generally at 2. Vehicle drive system 2 includes a first electric motor 4 coupled in tandem to a second electric motor 6 through a gear system 8. First electric motor 4 includes a first motor housing 10 having a first end 11 extending to a second end 12. First electric motor 4 is also shown to include a first motor shaft 14 having a first end portion 16 that extends from first end 11 of first motor housing 10 to a second end 17 that terminates at second end 12 of first motor housing 10. First end portion 16 is supported to first motor housing 10 by a first bearing 18 while second end portion 17 is rotatably supported to first motor housing 10 by a second bearing 19. Similarly, second electric motor 6 includes a second motor housing 20 having a first end 21 leading to a second end 22. Second electric motor 6 is also shown to include a second motor shaft 24 having a first end section 26 that extends from first end 21 of second motor housing 20 to a second end section 27 that terminates at second end 22 of second motor housing 20. First end section 26 is rotatably supported to second motor housing 20 by a first bearing 28 while second end section 27 is rotatably supported to second motor housing 20 by a second bearing 29.

First and second electric motors 4 and 6 are coupled to a drivetrain controller 30. Drivetrain controller 30 establishes a desired output speed and torque of each of first and second electric motors 4 and 6 through corresponding first and second motor controllers 32 and 33. More specifically, based on a sensed demand, such a desired change of speed or need for torque received through an input member 36, drive train controller 30 operates first and second electric motors 4 and 6 to achieve a desired output. That is, vehicle drive system 2 may be configured to operate under normal conditions with speed outputs from first and second electric motors 4 and 6 being synchronized. However, during a transient, such as a sudden acceleration or a change in elevation, drivetrain controller 30 changes the output from second motor shaft 24 to provide the desired speed and/or power as will become more fully evident below.

In accordance with the exemplary embodiment shown, gear system 8 includes a gear housing 46 having a first end 48 coupled to second electric motor 6 and a second end 49 coupled to first electric motor 4. Gear system 8 includes a planetary gear set 60 having a fixed gear ratio, coupled between first end portion 16 of first motor shaft 14 and second end section 27 of second motor shaft 24. Planetary gear set 60 includes an output shaft 62 that is coupled to second end section 27 of second motor shaft 24 through a gear pump 64. Gear pump 64 provides lubrication for gear system 8, bearings 18, 19; and 28, 29 as well as provides cooling to first and second electric motors 4 and 6. Within this arrangement, first and second motor shafts 14 and 24 extend along a single axis. Planetary gear set 60 establishes a desired additive input to second electric motor 6 from first electric motor 4. That is, first motor controller 32 establishes a desired operational speed and/or torque for first electric motor 4, the operational torque is transferred to second electric motor 6 via planetary gear set 60. The input from first electric motor 4 is added to second electric motor 6 to provide additional torque as driving conditions demand. The addition of gear system 8 allows first electric motor 4 to be operated at a different speed than that of second electric motor 6.

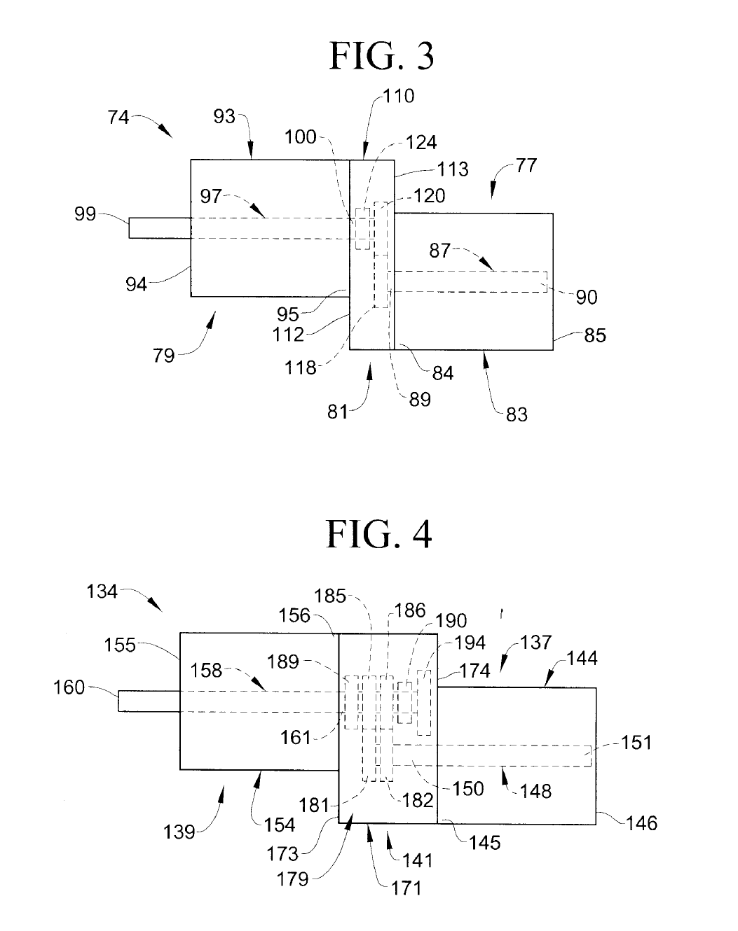

Reference will now be made to FIG. 3 in describing a vehicle drive system 74 in accordance with another aspect of the exemplary embodiment. Vehicle drive system 74 includes a first electric motor 77 and coupled in tandem to a second electric motor 79 through a gear system 81. First electric motor 77 includes a first motor housing 83 having a first end 84 that extends to a second end 85. First electric motor 77 is also shown to include a first motor shaft 87 having a first end portion 89 that extends from first end 84 of first motor housing 83 to a second end portion 90 that terminates at second end 85 of first motor housing 83. Similarly, second electric motor 79 includes a second motor housing 93 having a first end 94 leading to a second end 95. Second electric motor 79 is also shown to include a second motor shaft 97 having a first end section 99 that extends from first end 94 of second motor housing 93 to a second end section 100 that terminates at second end 95 of second motor housing 93. In a manner similar to that described above, first and second electric motors 77 and 79 are connected to corresponding first and second motor controllers (not shown) through a drivetrain controller (also not shown).

In accordance with the exemplary embodiment shown, gear system 81 includes a gear housing 110 having a first end 112 coupled to second end 95 of second motor housing 93 and a second end 113 that is coupled to first end 84 of first motor housing 83. Gear system 81 includes a first gear 118 mounted to first end portion 89 of first motor shaft 87 and a second gear 120 mounted to second end section 100 of second motor shaft 97. First gear 118 is off-set from, and selectively operatively connected to, second gear 120 establishing a fixed gear ratio. However, in this arrangement, first and second motor shafts 87 and 97 extend along different, i.e., off-set, axes. Gear system 81 is also shown to include a clutch member 124 that selectively engages first and second gears 118 and 120 and, by extension, first and second motor shafts 87 and 97. In this manner, first electric motor 77 may be powered only as demand requires and does not otherwise impose a drag on second electric motor 79.

Reference will now be made to FIG. 4 in describing a vehicle drive system 134 constructed in accordance with another aspect of the exemplary embodiment. Vehicle drive system 134 includes a first electric motor 137 coupled in tandem to a second electric motor 139 through a gear system 141. First electric motor 137 includes a first motor housing 144 having a first end 145 that extends to a second end 146. First electric motor 137 is also shown to include a first motor shaft 148 having a first end portion 150 that extends from first end 145 of first motor housing 144 to a second end portion 151 that terminates at second end 146 of first motor housing 144. Similarly, second electric motor 139 includes a second motor housing 154 having a first end 155 leading to a second end 156. Second electric motor 139 is also shown to include a second motor shaft 158 having a first end section 160 that extends from first end 155 of second motor housing 154 to a second end section 161 that terminates at second end 156 of second motor housing 154. In a manner similar to that described above, first and second electric motors 137 and 139 are connected to corresponding first and second motor controllers (not shown) through a drivetrain controller (also not shown).

In further accordance with the exemplary embodiment shown, gear system 141 includes a gear housing 171 having a first end 173 that is joined to second end 156 of second motor housing 154 and a second end 174 that is joined to first end 145 of first motor housing 144. Gear system 141 defines a transmission 179. Transmission 179 includes first and second gears 181 and 182 coupled to first end portion 150 of first motor shaft 148, and third and fourth gears 185 and 186. First gear 181 is selectively operatively coupled to third gear 185, and second gear 182 is selectively operatively coupled to fourth gear 186. More specifically, transmission 179 includes a first clutch member 189 coupled to second motor shaft 158 and operatively associated with first and third gears 181 and 185, and a second clutch member 190 coupled to second motor shaft 158 and operatively associated with second and fourth gears 182 and 186. First and third gears 181 and 185 establish a first gear ratio and second and fourth gears 182 and 186 establish a second gear ratio. With this arrangement, not only can first electric motor 137 be disengaged from second electric motor 139, when engaged, transmission 179 can establish multiple gear ratios to provide enhanced control as warranted by driving conditions. In addition, transmission 179 is shown to include a brake or parking pawl 194. Parking pawl 194 locks second motor shaft 158 when vehicle drive system 134 is inactive.

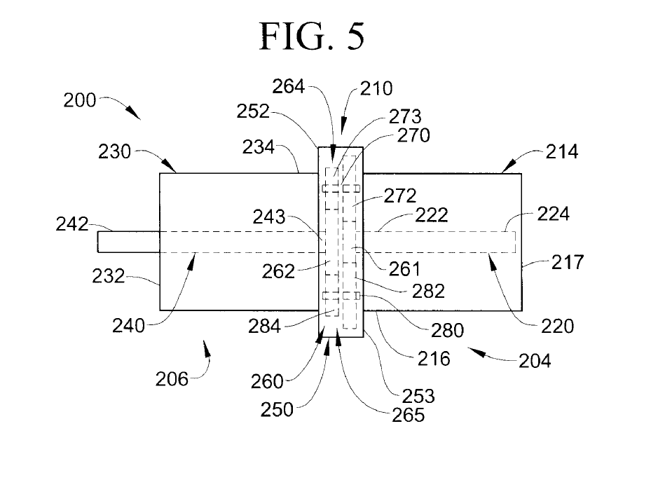

Reference will now be made to FIG. 5 in describing a vehicle drive system 200 constructed in accordance with another aspect of the exemplary embodiment. Vehicle drive system 200 includes a first electric motor 204 coupled in tandem to a second electric motor 206 through a gear system 210. First electric motor 204 includes a first motor housing 214 having a first end 216 that extends to a second end 217. First electric motor 204 is also shown to include a first motor shaft 220 having a first end portion 222 that extends from first end 216 of first motor housing 214 to a second end portion 224 that terminates at second end 217 of first motor housing 214. Similarly, second electric motor 206 includes a second motor housing 230 having a first end 232 leading to a second end 234. Second electric motor 206 is also shown to include a second motor shaft 240 having a first end section 242 that extends from first end 232 of second motor housing 230 to a second end section 243 that terminates at second end 234 of second motor housing 230. In a manner similar to that described above, first and second electric motors 204 and 206 are connected to corresponding first and second motor controllers (not shown) through a drivetrain controller (also not shown).

In further accordance with the exemplary embodiment shown, gear system 210 includes a gear housing 250 having a first end 252 that is joined to second end 234 of second motor housing 230 and a second end 253 that is joined to first end 216 of first motor housing 214. Gear system 210 defines a transmission 260. Transmission 260 includes a first gear 261 coupled to first end portion 222 of first motor shaft 220, and a second gear 262 coupled to second end section 243 of second motor shaft 240. First gear 261 is operatively coupled to second gear 262 through first and second gear systems 264 and 265. First gear system 264 includes an idler shaft 270 having mounted thereto third and fourth gears 272 and 273 that are operatively coupled to first and second gears 261 and 262 respectively. Second gear system 265 includes an idler shaft 280 having mounted thereto fifth and sixth gears 282 and 284 that are also operatively coupled to first and second gears 261 and 262 respectively. First and second gear systems 264 and 265 establish a desired gear ratio between first and second gears 261 and 262. The particular gear ratio established can vary depending upon the particular gears employed.

At this point it should be understood, that the exemplary embodiments provide a tandem electric motor vehicle drive system that increases an operational envelope of an associated vehicle. That is, the use of tandem electric motors that are controlled by associated motor controllers provides enhanced vehicle response to operational transients such as sudden accelerations and changes in incline (hill climbing ability). Moreover the use of multiple motor controllers and a gear system provides increased individual control of each electric motor. The gear system also enables one electric motor to be idle allowing another electric motor to be operated during normal road conditions. In this manner, the second electric motor need only be activated as required so that the vehicle drive system does not create an excessive battery drain.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A vehicle drive system comprising:
a first electric motor including a first motor housing and a first motor shaft;
a second electric motor including a second motor housing and a second motor shaft; and
a gear system operatively connecting the first motor shaft and the second motor shaft, the gear system being configured and disposed to transmit torque from the first motor shaft to the second motor shaft to form a tandem electric motor drive system.

2. The vehicle drive system according to claim 1, wherein the gear system includes a first gear coupled to the first motor shaft and a second gear coupled to the second motor shaft, the first gear being axially off-set from the second gear.

3. The vehicle drive system according to claim 2, further comprising: a clutch member operatively connected to one of the first and second motor shafts, the clutch member being selectively activated to disengage the first motor shaft from the second motor shaft.

4. The vehicle drive system according to claim 1, wherein the gear system includes a planetary gear set.

5. The vehicle drive system according to claim 1, wherein the first motor shaft extends along a first axis and the second motor shaft extends along a second axis, the first axis being substantially identical to the second axis such that the first electric machine is axially aligned with the second electric machine

6. The vehicle drive system according to claim 1, wherein the gear system includes at least one idler shaft having mounted thereto a plurality of gears, the plurality of gears operatively connecting the first and second motor shafts.

7. The vehicle drive system according to claim 1, wherein the gear system comprises a transmission having multiple gear ratios.

8. The vehicle drive system according to claim 7, wherein the transmission includes a first gear and a second gear operatively connected to the first motor shaft, and a third gear and a fourth gear operatively connected to the second motor shaft, one of the first and second gears being operatively connected to one of the third and fourth gears.

9. The vehicle drive system according to claim 1, further comprising: a controller operatively connected to the first and second electric motors, the controller establishing a desired operational torque for each of the first and second electric motors.

10. The vehicle drive system according to claim 9, further comprising:
a first motor controller operatively coupled between the controller and the first electric motor; and
a second motor controller operatively coupled between the controller and the second electric motor.

11. The vehicle drive system according to claim 1, further comprising: a gear housing surrounding the gear system.

12. The vehicle drive system according to claim 11, wherein the gear housing joins the first motor housing and the second motor housing.

13. A method of operating a tandem electric motor vehicle drive system, the method comprising:
activating a first electric motor having a first motor shaft; and
activating a second electric motor having a second motor shaft operatively connected to the first motor shaft through a gear system, output from the second electric motor adding to output from the first electric motor to provide a motive force to a vehicle.

14. The method of claim 13, further comprising: selectively activating a clutch connected to one of the first and second motor shafts to operatively disconnect the first electric motor and the second electric motor.

15. The method of claim 13, wherein activating the first electric motor comprises operating the first electric motor at a first parameter, and activating the second electric motor comprises operating the second electric motor at a second parameter.

16. The method of claim 15, further comprising: matching the first and second parameters.

17. The method of claim 15, further comprising: varying one of the first and second parameters from another of the first and second parameters.

18. The method of claim 15, wherein operating the first electric motor at the first parameter comprises establishing at least one of a first operational speed and a first output torque for the first electric motor and operating the second electric motor at the second parameter comprises establishing at least one of a second operational speed and a second output torque for the second electric motor.

19. The method of claim 13, further comprising: maintaining a fixed gear ratio between the first and second electric motors.

20. The method of claim 13, further comprising: varying a gear ratio between the first and second electric motors.
